(19) United States
(12) Patent Application Publication
(10) Pub. No.: US 2025/0192251 A1
(43) Pub. Date: Jun. 12, 2025

(54) Battery Management Device and Battery Management Method

(71) Applicant: SK On Co., Ltd., Seoul (KR)

(72) Inventor: Joo Won KANG, Daejeon (KR)

(21) Appl. No.: 18/973,261

(22) Filed: Dec. 9, 2024

(30) Foreign Application Priority Data
Dec. 11, 2023 (KR) 10-2023-0178819

(51) Int. Cl. H01M 10/44; B60L 53/16; B60L 53/62; B60L 58/18; H01M 10/42; H02J 7/00

(52) U.S. Cl. CPC H01M 10/441; B60L 53/16; B60L 53/62; B60L 58/18; H01M 10/425; H02J 7/0068; H01M 2010/4271; H01M 2220/20

(57) ABSTRACT

According to various embodiments, a battery management device including: a fast processing unit configured to process a first charge amount or a first discharge amount of a high-power battery in a fast processing mode to be higher than a second charge amount or a second discharge amount of a high-capacity battery; a slow processing unit configured to process the first charge amount or the first discharge amount of the high-power battery in a slow processing mode to be lower than the second charge amount or the second discharge amount of the high-capacity battery; and a mode determination unit configured to determine the fast processing mode or the slow processing mode according to a mode selection, and determine an operation of the fast processing unit or the slow processing unit according to the determined mode, and a battery management method may be provided.

### CROSS-REFERENCE TO RELATED APPLICATIONS

This application claims priority under 35 U.S.C. § 119(a) to Korean Patent Application No. 10-2023-0178819 filed on Dec. 11, 2023, in the Korean Intellectual Property Office, the entire disclosure of which is incorporated herein by reference.

### BACKGROUND OF THE INVENTION

### 1. Field of the Invention

The present disclosure relates to a device for managing batteries and a battery management method.

### 2. Description of the Related Art

As the demand for an electric vehicle rapidly increases, the demand for batteries which are essentially mounted in the electric vehicle is also increasing. In addition, due to intensifying competition in the battery market, various techniques are being developed to improve quality and performance of the battery while decreasing production costs.

In addition, in a situation where there are limitations that the higher an energy density of a battery material, the lower high output characteristics, an electric vehicle equipped with batteries having a high output while allowing to drive a long distance and a system for the same in order to compete with existing vehicles equipped with an internal combustion engine is required.

### SUMMARY OF THE INVENTION

It is an object of the present disclosure to provide a battery management device and a battery management method which may appropriately control batteries having various properties according to modes.

Problems to be solved through various embodiments are not limited to the above-described problem, and other problems not described above will be clearly understood by those skilled in the art from the following description.

To achieve the above object, according to an aspect of the present invention, there is provided a battery management device including: a fast processing unit configured to process a first charge amount or a first discharge amount of a high-power battery in a fast processing mode to be higher than a second charge amount or a second discharge amount of a high-capacity battery; a slow processing unit configured to process the first charge amount or the first discharge amount of the high-power battery in a slow processing mode to be lower than the second charge amount or the second discharge amount of the high-capacity battery; and a mode determination unit configured to determine the fast processing mode or the slow processing mode according to a mode selection, and determine an operation of the fast processing unit or the slow processing unit according to the determined mode.

Here, in the fast processing mode, the fast processing unit may process to perform charging or discharging of the high-power battery and then charging or discharging of the high-capacity battery, and in the slow processing mode, the slow processing unit may process to perform charging or discharging of the high-capacity battery and then charging or discharging of the high-power battery.

Here, in the fast processing mode, the fast processing unit may process to simultaneously perform charging or discharging of the high-power battery and the high-capacity battery at a preset ratio of the first charge amount and the second charge amount or a preset ratio of the first discharge amount and the second discharge amount, and in the slow processing mode, the slow processing unit may process to simultaneously perform charging or discharging of the high-power battery and the high-capacity battery at a preset ratio of the first charge amount and the second charge amount or a preset ratio of the first discharge amount and the second discharge amount.

Here, the device may further include a mode determination unit configured to determine the fast processing mode or the slow processing mode according to a mode selection, and determine an operation of the fast processing unit or the slow processing unit according to the determined mode.

Here, when a charging plug is combined to a charging port connected to the high-power battery and the high-capacity battery, the mode determination unit may process to charge the high-power battery and the high-capacity battery through the fast processing unit based on the power supplied through the charging plug, or charge the high-power battery and the high-capacity battery through the slow processing unit.

Here, the mode determination unit may process to discharge the high-power battery and the high-capacity battery through the fast processing unit, or discharge the high-power battery and the high-capacity battery through the slow processing unit, based on a speed change of acceleration according to a user input.

Here, the high-power battery may be a battery having a first maximum output and a first capacity, and the high-capacity battery may be a battery having a second maximum output lower than the first maximum output and a second capacity greater than the first capacity.

Here, the high-power battery or the high-capacity battery may be configured as cells, modules, or a pack.

According to another aspect of the present invention, there is provided a battery management method, including: according to a mode selection, by a mode determination unit, determining a fast processing mode of a battery configured to operate a fast processing unit or a slow processing mode of the battery configured to operate a slow processing unit; and in the fast processing mode, by the fast processing unit, processing a first charge amount or a first discharge amount of a high-power battery to be higher than a second charge amount or a second discharge amount of a high-capacity battery, or, in the slow processing mode, by the slow processing unit, processing the first charge amount or the first discharge amount of the high-power battery to be lower than the second charge amount or the second discharge amount of the high-capacity battery.

Here, the fast processing mode may process to perform charging or discharging of the high-power battery and then charging or discharging of the high-capacity battery, and the slow processing mode may process to perform charging or discharging of the high-capacity battery and then charging or discharging of the high-power battery.

Here, the fast processing mode may process to simultaneously perform charging or discharging of the high-power battery and the high-capacity battery at a preset ratio of the first charge amount and the second charge amount or a preset ratio of the first discharge amount and the second discharge amount, and the slow processing mode may process to simultaneously perform charging or discharging of the high-power battery and the high-capacity battery at a preset ratio of the first charge amount and the second charge amount or a preset ratio of the first discharge amount and the second discharge amount.

Here, when a charging plug is combined to a charging port connected to the high-power battery and the high-capacity battery, the method may process to charge the high-power battery and the high-capacity battery through the fast processing mode based on the power supplied through the charging plug, or charge the high-power battery and the high-capacity battery through the slow processing mode.

Here, the method may process to discharge the high-power battery and the high-capacity battery through the fast processing mode, or discharge the high-power battery and the high-capacity battery through the slow processing mode, based on a speed change of acceleration according to a user input.

Here, the high-power battery may be a battery having a first maximum output and a first capacity, and the high-capacity battery may be a battery having a second maximum output lower than the first maximum output and a second capacity greater than the first capacity.

Here, the high-power battery or the high-capacity battery may be configured as cells, modules, or a pack.

In addition, according to another aspect of the present invention, there is provided a battery system comprising the battery management device; and two or more battery units; wherein each of the two or more battery units comprises at least one of the high-power batteries or at least one of the high-capacity batteries.

Here, the battery management device may include: slave processing units connected to each of the two or more battery units; and a master processing unit connected to a plurality of the slave processing units.

Here, the master processing unit may include the mode determination unit, and each of the plurality of slave processing units may include the fast processing unit or the slow processing unit.

According to various embodiments, by forming batteries including cells with different properties and providing a battery management device capable of appropriately controlling them according to the cell properties, it is possible to achieve both the challenges for high output and high capacity of the battery.

According to various embodiments, a battery management device including a plurality of processing units by dividing, which are capable of appropriately control the cells with different properties according to the cell properties may be provided, thereby suppressing an occurrence of problems due to heat propagation that occurs during an operation of the cells.

According to various embodiments, a battery management device which is divided to control cells included in a battery system differently according to their properties may be provided, thereby allowing the cells to perform appropriate operations and functions according to their purpose, thus to maximize efficiency of the battery.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a conceptual diagram schematically illustrating the configuration of a battery system including a device and at least one battery according to an embodiment;

FIG. 2 is a conceptual diagram schematically illustrating the detailed configuration of the battery system including the device and at least one battery according to an embodiment;

FIG. 3 is a conceptual diagram schematically illustrating the detailed configuration of the battery system and at least one battery forming the battery system according to an embodiment;

FIG. 4 is a block diagram illustrating a processing unit for managing charging or discharging of the battery by dividing the operations depending on the functions thereof in the device according to an embodiment;

FIG. 5 is a flowchart illustrating procedures of an operation for determining a charging mode or a discharging mode of the battery in the device according to an embodiment;

FIG. 6 is a flowchart illustrating procedures for performing a fast processing mode or a slow processing mode in the device according to an embodiment;

FIG. 7 is a flowchart illustrating procedures for performing a fast processing mode or a slow processing mode after determining to perform a charging mode in the device according to an embodiment; and

FIG. 8 is a flowchart illustrating procedures for performing a fast processing mode or a slow processing mode after determining to perform a discharging mode in the device according to an embodiment.

### DETAILED DESCRIPTION OF THE INVENTION

Hereinafter, embodiments will be described in detail with reference to the accompanying drawings. However, since various changes may be made in the embodiments, the scope of the patent invention is not limited or restricted by these embodiments. It should be understood that all modifications, equivalents, and alternatives for the embodiments are included in the scope of the present invention.

The terms used in the embodiments are used only for the purpose of describing the invention, and should not be interpreted as limiting. As used herein, the singular forms “a,” “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or combinations thereof.

Unless otherwise defined, all terms including technical or scientific terms used herein have the same meaning as commonly understood by one of ordinary skill in the art to which the present invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Further, in describing the embodiments with reference to the accompanying drawings, the same reference numerals are denoted to the same components regardless of the number of the drawings, and the same configuration will not be repeatedly described. Further, in description of the embodiments, the publicly known techniques related to the present invention, which are verified to be able to make the purport of the present invention unnecessarily obscure, will not be described in detail.

In addition, in describing components of the embodiment, the terms such as first, second, A, B, (a), (b), and the like may be used. These terms are intended to divide the components from other components, and do not limit the nature, sequence or order of the components.

It will be understood that when a component is described to as being “connected,” “combined” or “coupled” to another component, the component may be directly connected or coupled the another component, but it may be “connected,” “combined” or “coupled” to the another component intervening another component may be present.

In addition, it will be understood that when a component is described as being “connected” or “combined” by communication to another component, that component may be connected or combined by wireless or wired communication to the another component, but it may be “connected” or “combined” to the another component intervening another component may be present.

Further, in describing the components of the embodiment, the meaning of “or” may mean each of the components, may mean two or more of the components, or may mean all of the components. For example, it should be understood that the expressions “a, b or c” represent any one of “a,” “b,” “c,” “a and b,” “a and c,” “b and c,” and “a, b and c.”

Components included in one embodiment and components including common functions will be described using the same names in other embodiments. The description given in one embodiment may be applied to other embodiments, and therefore will not be described in detail within the overlapping range, unless there is a description opposite thereto.

The device and/or ‘data’ processed by the device may be expressed in terms of ‘information’. Here, the information may be used as a concept including the data.

The present disclosure describes a battery management device and a battery management method. To describe in more detail, a system and method for controlling a charge amount or a discharge amount of batteries classified into two or more types (or properties) according to charging and discharging modes of the battery will be described.

According to an embodiment, the battery may be configured as a battery built into a vehicle. For example, the battery according to various embodiments may include at least one of various secondary batteries such as a lithium iron phosphate (LiFePO₄) battery and a lithium ion (Li-ion) battery.

The battery management device according to various embodiments may be configured as a battery management system (BMS) or a part thereof. Hereinafter, various embodiments of the present disclosure will be described with reference to the accompanying drawings. However, the drawings attached to the present specification serve to further understand the technical idea together with the detailed description, such that the present disclosure should not be construed as being limited only to the illustrations of the drawings.

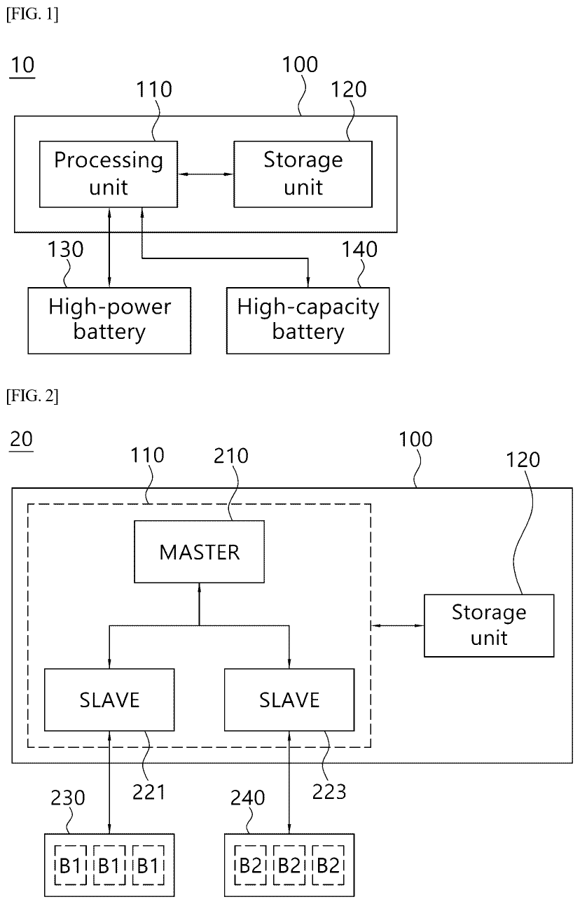

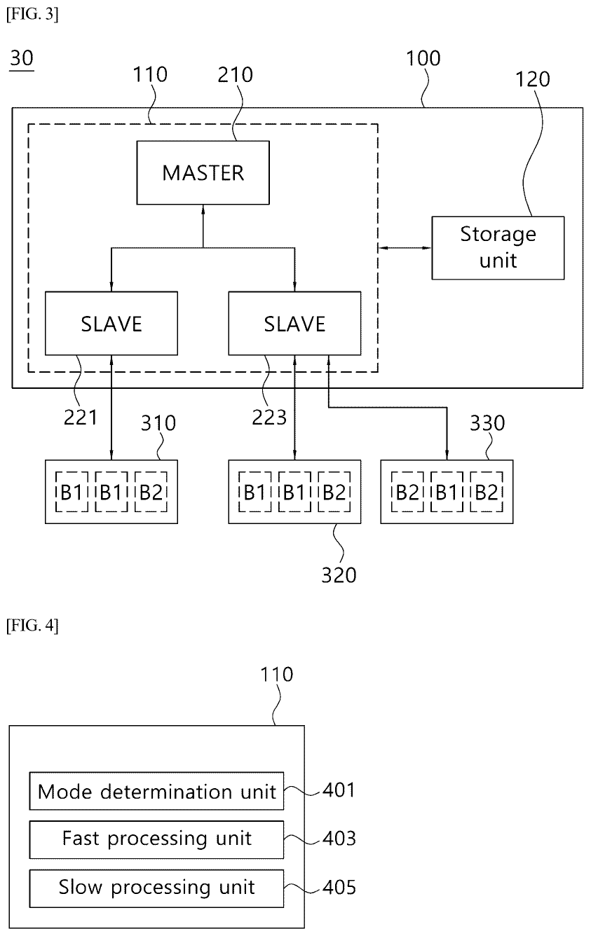

FIG. 1 is a conceptual diagram schematically illustrating the configuration of a battery system including a device and at least one battery according to an embodiment. FIG. 2 is a conceptual diagram schematically illustrating the detailed configuration of the battery system including the device and at least one battery according to an embodiment. FIG. 3 is a conceptual diagram schematically illustrating the detailed configuration of the battery system and at least one battery forming the battery system according to an embodiment.

First, referring to FIG. 1, a battery management device 100 (hereinafter, a device 100) may include a processing unit 110 and a storage unit 120. In addition, the device 100 may form a battery system 10 together with at least one battery.

According to various embodiments, the battery forming the battery system 10 may include a battery with a focus on high power output (or, a high-performance battery) (hereinafter, a high-power battery) 130 and a battery with a focus on high capacity (or, a high-capacity battery) 140 (hereinafter, a high-capacity battery).

Here, the high-power battery may be configured as a battery which satisfies at least some of the conditions of a high discharge rate, a low internal resistance, and a low energy density. In addition, the high-capacity battery may be configured as a battery which satisfies at least some of the conditions of a low discharge rate, a low internal resistance, and a high energy density.

According to an embodiment, as shown in FIG. 1, it may be assumed the battery system 10 including a high-power battery 130 and a high-capacity battery 140. At this time, the high-power battery 130 may be configured to have a relatively high discharge rate, a relatively low internal resistance, and/or a relatively low energy density compared to the high-capacity battery 140.

Similarly, the high-capacity battery 140 may be configured to have a relatively lower discharge rate, a relatively higher internal resistance, and/or a relatively higher energy density compared to the high-power battery 130.

Here, since the lower the internal resistance, the higher the battery efficiency, both the high-power battery 130 and the high-capacity battery 140 may be configured to have the same or similar internal resistance without artificially differentiating therebetween.

As described above, the high-power battery 130 and the high-capacity battery 140 may be configured to have differences in the discharge rate, internal resistance, and/or energy density during the design and production processes.

However, it is not limited thereto, and when the high-power battery 130 and the high-capacity battery 140 include two batteries having the same specifications, one battery may be set as the high-power battery 130 and the other battery as the high-capacity battery 140, by diagnosing and comparing the discharge rate, internal resistance, and/or energy density.

In other words, the high-power battery 130 may be configured to have a higher maximum output than the high-capacity battery 140, and the high-capacity battery 140 may be configured to have a higher capacity than the high-power battery 130. However, it is not limited thereto, and the high-power battery 130 and the high-capacity battery 140 may be configured to have the same capacity.

At least some batteries of the high-power batteries 130 and the high-capacity batteries 140 include at least one cell, and at least some batteries of the high-power batteries 130 and the high-capacity batteries 140 may be configured as a battery pack or battery module.

For example, the battery module may include two or more cells, and the battery pack may include at least one battery module. In describing various embodiments, at least some batteries of the high-power batteries 130 and the high-capacity batteries 140 may be configured as cells, modules, or a pack.

In addition, as shown through FIGS. 2 and 3, one battery unit 230, 240, 310, 320 or 330 may be formed by including at least one high-power battery 130 (B1) and/or at least one high-capacity battery 140 (B2).

First, referring to FIG. 2, the battery system 20 may include at least some of the processing unit 110, the storage unit 120, and at least one battery unit 230 or 240.

Further, referring to FIG. 3, the battery system 30 may include at least some of the processing unit 110, the storage unit 120, and at least one battery unit 310, 320 or 330.

Here, at least some of the battery units 230 and 240 may include batteries of the same type. To describe in more detail, the battery unit 230 may include a plurality of high-power batteries 130 (B1). Similarly, the battery unit 240 may include a plurality of high-capacity batteries 140 (B2).

However, it is not limited thereto, and as shown in FIG. 3, each of the battery units 310, 320 and 330 may include at least one high-power battery 130 (B1) and at least one high-capacity battery 140 (B2). At this time, each of the battery units 310, 320 and 330 may be configured so that the high-power battery 130 (B1) and the high-capacity battery 140 (B2) are arranged according to a designated pattern.

Referring to FIGS. 1 to 3, each of the high-power battery 130, the high-capacity battery 140, and the battery units 230, 240, 310, 320 and 330 including at least some of the high-power batteries 130 and the high-capacity batteries 140 may be connected to the processing unit 110 of the device 100.

Here, when the battery units 230, 240, 310, 320 and 330 are configured as the battery pack, the high-power batteries 130 (B1) or the high-capacity batteries 140 (B2) included in each of the battery units 230, 240, 310, 320 and 330 may be configured as the cells or battery modules. However, it is not limited thereto, and when the battery units 230, 240, 310, 320 and 330 are configured as the battery module, the high-power batteries 130 (B1) or the high-capacity batteries 140 (B2) included in each of the battery units 230, 240, 310, 320 and 330 may be configured as the cells.

Referring to FIGS. 2 and 3, the battery units 230, 240, 310, 320 and 330 connected with the device 100 are shown as including three batteries (e.g., the high-power batteries 130 (B1) and/or the high-capacity batteries 140 (B2)). However, it is not limited thereto, and the battery units connected with the device 100 (or included in the device 100) may include various numbers of the batteries.

Returning to FIG. 1 again, the processing unit 110 includes at least one processor (or controller), and may process control commands related to management of at least one battery connected thereto through at least one program (application, tool, plug, software, etc., hereinafter referred to as a battery management program). At this time, the battery management program may be stored in the storage unit 120 of the device 100 or a storage unit of another device connected to the device 100.

The processing unit 110 may share data processing or processing results with at least one other device (e.g., a user device) connected to the device 100 through the battery management program.

Hereinafter, in various embodiments, it may be understood that performing an operation according to the control commands by the device 100 indicates performing an operation designated through at least one program or the battery management program related to at least one control command processing of the device 100.

Here, it will be described that the control command processing is performed through the at least one program or the battery management program installed in the device 100, but it is not limited thereto, and may be performed through another program or a temporary installation program previously installed in the storage unit 120.

According to an embodiment, the control command processing may be performed through at least a portion of a database provided free of charge or for a fee in an external device connected to the device 100.

The operation of the device 100 is performed based on the data processing and device control of the processing unit 110, and the processing unit 110 may also perform functions designated on the basis of the control commands received through an input/output unit or the communication unit of the device 100.

Further, in processing data acquired through the communication unit 130, the processing unit 110 may process the data based on an identified user. For example, the processing unit 110 may perform an operation according to the control command input by the user device connected to the device through the communication unit 130 and/or the identified user who has been identified through user information.

According to one embodiment, when the device 100 is configured as a battery management system (or a portion thereof), the processing unit 110 is configured as the battery management unit (BMU), or may be configured to perform at least some functions of the battery management unit.

The storage unit 120 may store various data processed by at least one component (e.g., the processing unit 110 or the communication unit 130) of the device 100. The data may include, for example, a program for control command processing or data processed through the program, or input data and output data related thereto.

The storage unit 120 may include an algorithm for control command processing, which includes at least some of an artificial neural network algorithm, a blockchain algorithm, a deep learning algorithm, and a regression analysis algorithm, as well as mechanisms, operators, language models, and big data related thereto.

The storage unit 120 may include data for confirming and processing control and operations designated through signals received by each component included in the input/output unit.

The operations described through the storage unit 120 are processed by the processing unit 110, and data for processing the related operations, data in process, processed data, preset data, and the like may be stored in the storage unit 120 as a database.

The data stored in the storage unit 120 may be changed, modified, deleted, or generated as new data by the processing unit 110 based on user input of the identified user.

The storage unit 120 may store device setting information of the device 100. The device setting information may be setting information on the device 100 and at least some of functions and services provided by the device 100.

The storage unit 120 may store user information (or user account) for at least one user.

The storage unit 120 may include a volatile memory, a non-volatile memory, and/or a computer-readable recording medium as known in the art. In this case, the computer-readable recording medium may store a computer program for performing an operation to determine an abnormality in circuits of the battery by the device 100 based on various embodiments.

In addition, according to various embodiments, the device 100 may further include at least some elements of at least one communication unit and at least one sensing unit.

The communication unit may support establishment of a wired communication channel or establishment of a wireless communication channel between the device 100 and at least one other device (e.g., the user device or a server), and performing communication through the established communication channel.

The communication unit may perform operations such as modulation/demodulation and encryption/decryption, etc., during performing communication, which is obvious to those skilled in the art, and therefore will not be described in more detail.

The communication unit 130 may be operated dependently on or independently from the processing unit 110, and may include one or more communication processors which support wireless communication and/or wired communication.

According to an embodiment, when supporting the wireless communication, the communication unit 130 may include at least some communication modules of wireless communication modules, for example, a cellular communication module, a near field communication module, and a global navigation satellite system (GNSS) communication module.

When supporting the wired communication, the communication unit may include at least some communication modules of wired communication modules, for example, a local area network (LAN) communication module, a power line communication module, a controller area network (CAN) communication module, and a serial peripheral interface (SPI).

According to various embodiments, the communication unit may be configured to communicate with the external device by wired and/or wirelessly through near field communication networks such as Bluetooth, Bluetooth Low Energy (BLE), WiFi, WiFi direct, Infrared Data Association (IrDA), ZigBee, UWB, and radio frequency (RF), or far field communication networks such as a cellular network, the Internet or a computer network (e.g., LAN or WAN).

Various types of communication modules constituting the communication unit may be integrated into one component (e.g., a single chip), or may be implemented as a plurality of separate components (e.g., a plurality of chips).

The communication unit may be configured to perform communication between the processing unit 110 and an external device of the device 100. However, it is not limited thereto, and the communication unit may be configured to perform communication with at least some of the internal components of the device 100, such as the storage unit 120, the high-power battery 130, the high-capacity battery 140, and the battery units 230, 240, 310, 320 and 330.

The sensing unit may monitor the state of the battery connected to the device 100. At this time, the sensing unit may transmit monitoring results to the processing unit 110.

To describe the configuration of the sensing unit in more detail, the sensing unit may include at least some of a voltage measurement circuit configured to measure and manage a voltage of the battery, a current measurement circuit configured to measure and manage a current of the battery, a battery state estimation unit configured to estimate a state of the battery based on information received from the voltage measurement circuit or the current measurement circuit, and a temperature measurement circuit configured to measure a temperature of the battery based on a temperature sensor.

According to various embodiments, the device 100 may be provided as a device connected to the battery and included in a vehicle as described above.

According to various embodiments, the device 100 or user device may include at least some of the functions in the range of all information and communication devices, including a mobile terminal, a multimedia terminal, a wired terminal, a fixed terminal, and an internet protocol (IP) terminal.

The device 100 a device for processing the control commands, and may include at least some of the functions of a workstation or a large-scale database, or may be connected therewith through communication.

As the user device connected to the device 100, a mobile phone, a personal computer (PC), a portable multimedia player (PMP), a mobile internet device (MID), a smartphone, a tablet PC, a phablet PC, a laptop computer, and the like may be exemplified.

As described above, the device 100 may include some of the battery management device configured to manage at least some of the batteries connected to the device 100, for example, the high-power batteries 130, the high-capacity batteries 140, and the battery units 230, 240, 310, 320 and 330, or the battery management system, and may be configured as a device for managing the batteries.

Hereinafter, an operation of managing the battery by the device 100 will be described in detail with reference to the drawings. FIG. 4 is a block diagram illustrating a processing unit for managing charging or discharging of the battery by dividing the operations depending on the functions thereof in the device according to an embodiment.

Referring to FIG. 4, the processing unit 110 may include a mode determination unit 401, a fast processing unit 403, and a slow processing unit 405.

The mode determination unit 401 may determine whether to charge the battery (or operate in a charging mode) or discharge it (or operate in a discharging mode).

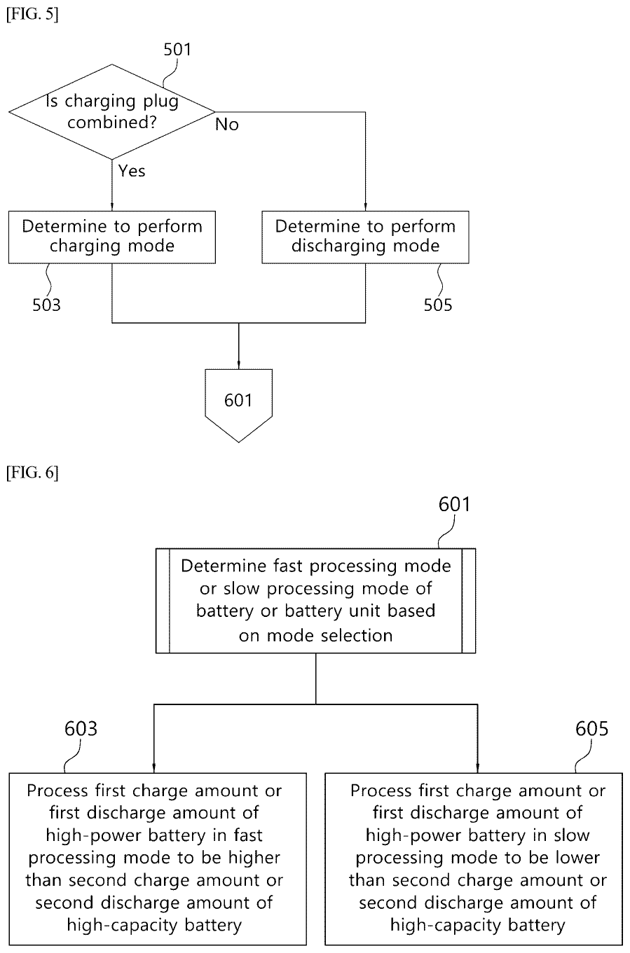

In this regard, FIG. 5 is a flowchart illustrating procedures of an operation for determining the charging mode or the discharging mode of the battery in the device according to an embodiment.

Referring to FIG. 5, when the battery system 10, 20 or 30 is a system forming an electric vehicle (or a hybrid vehicle, hereinafter referred to as an electric vehicle), the mode determination unit 401 may check (501) whether a charging plug (not shown) is connected to a charging port (not shown) of the electric vehicle.

For example, when the charging plug is connected to the charging port of the vehicle (or a control unit of the vehicle), the mode determination unit 401 may receive a message on the connection of the charging plug to the charging port from the control unit (not shown) of the vehicle.

Here, the message may include at least some pieces of information of the type of the charging port or plug, a charging speed, and a charging method.

To describe in more detail, the type of the charging port or plug may include a combined type of the charging port or plug among various types of the charging port or plug such as CHAdeMO, CCS (Combined Charging System), Tesla Supercharger, AC Type 1, AC Type 2, GB/T (GuanBiaoTong), Type 3, and IEC 62196 (Mennekes).

In addition, the charging speed is a speed at which the battery is charged depending on the type of the combined charging port or plug, and may be provided in units of kilowatt (kW) or kilowatt-hour (kW-h).

In addition, the charging method may be classified into a fast charging method or a slow charging method, etc., as a charging method provided depending on the type of the charging port or plug, or depending on the charging speed.

The mode determination unit 401 may determine (503) to perform a charging mode of the battery if it is determined that the charging plug is combined, and may determine (505) to perform a discharging mode of the battery if it is determined that the charging plug is not combined.

Thereafter, the processing unit 110 may determine a fast processing mode or a slow processing mode when performing charging or discharging determined on the battery or battery unit.

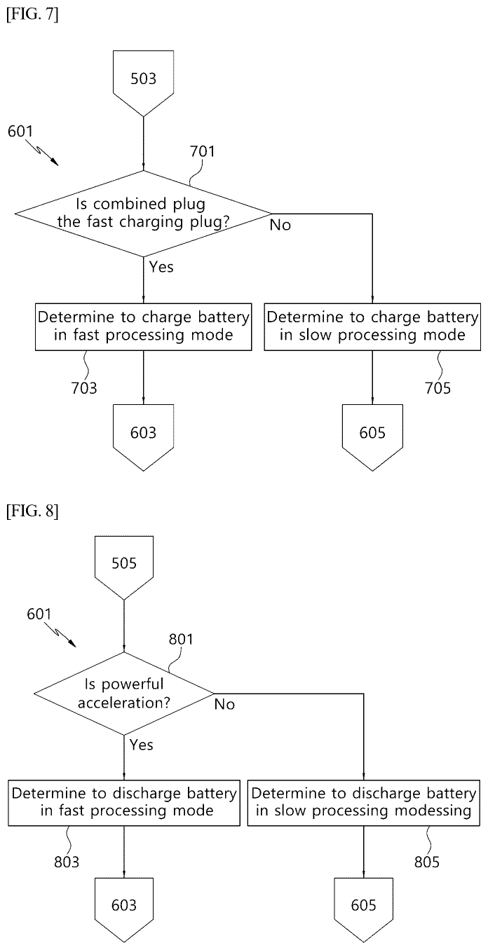

In this regard, FIG. 6 is a flowchart illustrating procedures for performing a fast processing mode or a slow processing mode in the device according to an embodiment. FIG. 7 is a flowchart illustrating procedures for performing a fast processing mode or a slow processing mode after determining to perform a charging mode in the device according to an embodiment. In addition, FIG. 8 is a flowchart illustrating procedures for performing a fast processing mode or a slow processing mode after determining to perform a discharging mode in the device according to an embodiment.

In describing various embodiments of the present invention, when the device 100 is included as a component of the vehicle, the fast processing mode may be configured as a mode related to at least some of fast charging, sports driving, performance driving, and launch control, and the slow processing mode may be configured as a mode related to at least some of slow charging, fuel efficiency driving, and coaster driving.

First, referring to FIG. 6, the mode determination unit 401 may determine (601) the fast processing mode or the slow processing mode of the battery or the battery unit based on a mode selection. In addition, the mode determination unit 401 may determine an operation of the fast processing unit 403 or the slow processing unit 405 according to the determined fast processing mode or slow processing mode.

Here, the operation of determining the fast processing mode or the slow processing mode may be configured to perform according to the operation of determining to perform the charging mode or the operation of determining to perform the discharging mode of FIG. 5.

For example, when the mode determination unit 401 determines (503) to perform the charging mode, as shown in FIG. 7, the mode determination unit 401 may determine (701) whether the combined charging plug is a fast charging plug.

To describe in more detail, the mode determination unit 401 may determine whether the combined charging plug is a fast charging plug or a slow charging plug based on the power supplied through the charging plug.

However, it is not limited thereto, and the mode determination unit 401 may determine whether the combined charging plug is the fast charging plug based on a message received after the charging plug is combined.

For example, the mode determination unit 401 may determine whether the combined charging plug is the fast charging plug based on at least some pieces of information among the type of the charging port or plug, charging speed, and charging method included in the received message.

If it is determined that the combined charging plug is the fast charging plug, the mode determination unit 401 may determine (703) to charge the battery in the fast processing mode. On the other hand, if it is determined that the combined charging plug is not the fast charging plug, the mode determination unit 401 may determine (705) to charge the battery in the slow processing mode.

According to the above description, it has been described that the mode determination unit 401 determines (703) to charge the battery in the fast processing mode or determines (705) to charge the battery in the slow processing mode depending on whether the combined charging plug is the fast charging plug. However, it is not limited thereto, and it is possible to determine (703) to charge the battery in the fast processing mode or to determine (705) to charge the battery in the slow processing mode based on whether the remaining capacity on the bases of the combined plug is in the fast chargeable state or the slow chargeable state.

In addition, the mode determination unit 401 may determine (703) to charge the battery in the fast processing mode or determine (705) to charge the battery in the slow processing mode based on the user input received from the vehicle (or the control unit of the vehicle).

If the mode determination unit 401 determines (703) to charge the battery in the fast processing mode, the fast processing unit 403 may process to charge the battery in the fast processing mode in operation 603. On the other hand, if the mode determination unit 401 determines (705) to charge the battery in the slow processing mode, the slow processing unit 405 may process to charge the battery in the slow processing mode in operation 605.

Returning to FIG. 5 again, for another example, if the mode determination unit 401 determines (505) to perform the discharging mode, as shown in FIG. 8, the mode determination unit 401 may check a speed change of acceleration and determine (801) whether it is powerful acceleration.

Here, the mode determination unit 401 may receive acceleration information related to an operation of an accelerator pedal for controlling a speed of the vehicle from the vehicle (or the control unit of the vehicle).

The mode determination unit 401 checks an acceleration pattern from the received acceleration information, and if it is determined that the acceleration pattern matches the powerful acceleration pattern set to rapid acceleration or rapid deceleration based on a preset pattern, may determine (803) to discharge the battery in the fast processing mode.

On the other hand, if it is determined that the acceleration pattern matches a weak acceleration pattern set to gentle acceleration or gentle deceleration based on the preset pattern, the mode determination unit may determine (805) to discharge the battery in the slow processing mode.

Here, the acceleration pattern is determined based on at least some of an acceleration value, and the change speed of acceleration, and according to the above description, it may be divided into the powerful acceleration pattern and the weak acceleration pattern, and patterns thereof may be preset.

However, it is not limited thereto, and the acceleration pattern may be variously set and stored (e.g., stored in the storage unit 120) as two or more patterns, for example, the powerful acceleration pattern, a general acceleration pattern, and the weak acceleration pattern, based on at least some of the acceleration value and the change speed of acceleration.

In addition, the mode determination unit 401 may determine (803) to discharge the battery in the fast processing mode or determine (805) to discharge the battery in the slow processing mode based on the user input received from the vehicle (or the control unit of the vehicle).

If the mode determination unit 401 determines (803) to discharge the battery in the fast processing mode, the fast processing unit 403 may process to discharge the battery in the fast processing mode in operation 603. On the other hand, if the mode determination unit 401 determines (805) to discharge the battery in the slow processing mode, the slow processing unit 405 may process to discharge the battery in the slow processing mode in operation 605.

Returning to FIG. 6 again, as described above, the fast processing unit 403 may process 603 the charge amount or discharge amount of the high-power battery in the fast processing mode to be higher than the charge amount or discharge amount of the high-capacity battery.

Here, as described above, the operation 603 may be configured to perform according to an operation of determining (703) to charge the battery in the fast processing mode of FIG. 7 or an operation of determining (803) to discharge the battery in the fast processing mode of FIG. 8.

First, according to an embodiment, when performing the operation 603 according to the operation of determining (703) to charge the battery in the fast processing mode of FIG. 7, the fast processing unit 403 may process to charge so that a charge amount of the high-power battery 130 (B1) is higher than the charge amount of the high-capacity battery 140 (B2).

For example, the fast processing unit 403 controls the power provided through the charging plug, and may process to supply the power provided through the charging plug to the high-power battery 130 (B1) at a higher ratio than the high-capacity battery 140 (B2) according to a preset ratio.

To describe in more detail, when charging the battery in the fast processing mode, a ratio of a supplying power to the high-power battery 130 (B1) and a supplying power to the high-capacity battery 140 (B2) may be set to be 8:2.

To describe it again based on this state, the fast processing unit 403 may process to supply 80% of the power provided through the charging plug to the high-power battery 130 (B1), and supply 20% to the high-capacity battery 140 (B2).

At this time, in a state where the power amount for battery charging is determined, the fast processing unit 403 may process to perform charging of the high-power battery 130 (B1) using 80% of the determined power amount, and then perform charging of the high-capacity battery 140 (B2) using the remaining 20% of the determined power amount.

Alternatively, the fast processing unit 403 may process to perform charging of the high-power battery 130 (B1) until it reaches a preset state of charge (SoC), and then perform charging of the high-capacity battery 140 (B2) until it reaches the preset state of charge (SoC).

In addition, it is not limited thereto, and the fast processing unit 403 simultaneously performs charging of the high-power battery 130 (B1) and the high-capacity battery 140 (B2), and may process to distribute and supply 80% of the power provided from the charging plug to the high-power battery 130 (B1), and supply 20% to the high-capacity battery 140 (B2).

According to various embodiments, it may be assumed that the device 100 is connected to at least one battery unit as described above, and the at least one battery unit includes the plurality of high-power batteries 130 (B1) and the plurality of high-capacity batteries 140 (B2).

At this time, the fast processing unit 403 may process to evenly distribute and supply 80% of the power provided through the charging plug to the plurality of high-power batteries 130 (B1), then evenly distribute and supply 20% of the power provided through the charging plug to the high-capacity batteries 140 (B2).

According to the above description, it has been described that the ratio of the power supplied to the high-power battery 130 (B1) and the power supplied to the high-capacity battery 140 (B2) is set to be 8:2. However, the ratio set for the high-power battery 130 (B1) may be changed within a range of 100% to 50% according to the setting.

According to another embodiment, when performing the operation 603 according to the operation of determining (803) to discharge the battery in the fast processing mode of FIG. 8, the fast processing unit 403 may process to discharge so that a discharge amount (or an amount of used power) of the high-power battery 130 (B1) is higher than the discharge amount (or the amount of used power) of the high-capacity battery 140 (B2).

For example, the fast processing unit 403 controls the power output from the battery corresponding to the received acceleration information, and may process to output the power from the high-power battery 130 (B1) at a higher ratio than the high-capacity battery 140 (B2) according to the preset ratio.

To describe in more detail, when discharging the battery in the fast processing mode, a ratio of a discharging power from the high-power battery 130 (B1) and a discharging power from the high-capacity battery 140 (B2) may be set to be 8:2.

To describe it again based on this state, the fast processing unit 403 may process to discharge, for the power set to be output corresponding to the acceleration information, 80% of the set power from the high-power battery 130 (B1), and discharge 20% of the set power from the high-capacity battery 140 (B2).

At this time, the fast processing unit 403 may process to distribute and simultaneously discharge the high-power battery 130 (B1) and the high-capacity battery 140 (B2) according to the preset ratio.

However, it is not limited thereto, and the fast processing unit 403 may process to perform discharging of the high-power battery 130 (B1) until it reaches a preset state of charge (SoC) or a preset depth of discharge (DOD), and then perform discharging of the high-capacity battery 140 (B2) until it reaches the preset state of charge (SoC) or the preset depth of discharge (DOD).

According to various embodiments, it may be assumed that the device 100 is connected to at least one battery unit as described above, and the at least one battery unit includes the plurality of high-power batteries 130 (B1) and the plurality of high-capacity batteries 140 (B2).

At this time, the fast processing unit 403 may process to evenly distribute and output 80% of the power set to be output for the acceleration information from the plurality of high-power batteries 130 (B1), then evenly distribute and output 20% of the set power from the high-capacity batteries 140 (B2).

According to the above description, it has been described that the ratio of the power discharged from the high-power battery 130 (B1) and the power discharged from the high-capacity battery 140 (B2) is set to be 8:2. However, the ratio set for the high-power battery 130 (B1) may be changed within the range of 100% to 50% according to the setting.

Returning to FIG. 6 again, according to the above description, the slow processing unit 405 may process 605 the charge amount or discharge amount of the high-power battery in the slow processing mode to be lower than the charge amount or discharge amount of the high-capacity battery.

Here, as described above, the operation 605 may be configured to perform according to the operation of determining (705) to charge the battery in the slow processing mode of FIG. 7 or the operation of determining (805) to discharge the battery in the slow processing mode of FIG. 8.

First, according to an embodiment, when performing the operation 605 according to the operation of determining (705) to charge the battery in the slow processing mode of FIG. 7, the slow processing unit 405 may process to charge so that the charge amount the high-power battery 130 (B1) is lower than the charge amount of the high-capacity battery 140 (B2).

For example, the slow processing unit 405 controls the power provided through the charging plug, and may process to supply the power provided through the charging plug to the high-power battery 130 (B1) at a lower rate than the high-capacity battery 140 (B2) according to the preset ratio.

To describe in more detail, when charging the battery in the slow processing mode, the ratio of the supplying power to the high-power battery 130 (B1) and the supplying power to the high-capacity battery 140 (B2) may be set to be 2:8.

To describe it again based on this state, the slow processing unit 405 may process to supply 20% of the power provided through the charging plug to the high-power battery 130 (B1), and 80% to the high-capacity battery 140 (B2).

At this time, in a state where the power amount for battery charging is determined, the slow processing unit 405 may process to perform charging of the high-capacity battery 140 (B2) using 80% of the determined power amount, and then perform charging of the high-power battery 130 (B1) using the remaining 20% of the determined power amount.

Alternatively, the slow processing unit 405 may process to perform charging the high-capacity battery 140 (B2) until it reaches the preset state of charge (SoC), and then perform charging of the high-power battery 130 (B1) until it reaches the preset state of charge (SoC).

In addition, it is not limited thereto, and the slow processing unit 405 simultaneously performs charging of the high-power battery 130 (B1) and the high-capacity battery 140 (B2), and may process to distribute and supply 20% of the power provided from the charging plug to the high-power battery 130 (B1) and supply 80% to the high-capacity battery 140 (B2).

According to various embodiments, it may be assumed that the device 100 is connected to at least one battery unit as described above, and the at least one battery unit includes the plurality of high-power batteries 130 (B1) and the plurality of high-capacity batteries 140 (B2).

At this time, the slow processing unit 405 may process to evenly distribute and supply 20% of the power provided through the charging plug to the plurality of high-power batteries 130 (B1), then evenly distribute and supply 80% of the power provided through the charging plug to the high-capacity batteries 140 (B2).

According to the above description, it has been described that the ratio of the power supplied to the high-power battery 130 (B1) and the power supplied to the high-capacity battery 140 (B2) is set to be 2:8. However, the ratio set for the high-capacity battery 140 (B2) may be changed within the range of 100% to 50% according to the setting.

According to another embodiment, when performing the operation 605 according to the operation of determining (805) to discharge the battery in the slow processing mode of FIG. 8, the slow processing unit 405 may process to discharge so that the discharge amount (or the amount of used power) of the high-power battery 130 (B1) is lower than the discharge amount (or the amount of used power) of the high-capacity battery 140 (B2).

For example, the slow processing unit 405 controls the power output from the battery corresponding to the received acceleration information, and may process to output the power from the high-power battery 130 (B1) at a lower rate than the high-capacity battery 140 (B2) according to the preset ratio.

To describe in more detail, when discharging the battery in the slow processing mode, the ratio of the discharging power from the high-power battery 130 (B1) and the discharging power from the high-capacity battery 140 (B2) may be set to be 2:8.

To describe it again based on this state, the slow processing unit 405 may process to discharge, for the power set to be output corresponding to the acceleration information, 20% of the set power from the high-power battery 130 (B1), and discharge 80% of the set power from the high-capacity battery 140 (B2).

At this time, the slow processing unit 405 may process to distribute and simultaneously discharge the high-power battery 130 (B1) and the high-capacity battery 140 (B2) according to the preset ratio.

However, it is not limited thereto, and the slow processing unit 405 may process to perform discharging of the high-power battery 130 (B1) until it reaches a preset state of charge (SoC) or a preset depth of discharge (DOD), and then perform discharging of the high-capacity battery 140 (B2) until it reaches the preset state of charge (SoC) or the preset depth of discharge (DOD).

According to various embodiments, it may be assumed that the device 100 is connected to at least one battery unit as described above, and the at least one battery unit includes the plurality of high-power batteries 130 (B1) and the plurality of high-capacity batteries 140 (B2).

At this time, the slow processing unit 405 may process to evenly distribute and output 20% of the power set to be output for the acceleration information from the plurality of high-power batteries 130 (B1), then evenly distribute and output 80% of the set power from the high-capacity batteries 140 (B2).

According to the above description, it has been described that the ratio of the power discharged from the high-power battery 130 (B1) and the power discharged from the high-capacity battery 140 (B2) is set to be 2:8. However, the ratio set for the high-capacity battery 140 (B2) may be changed within the range of 100% to 50% according to the setting. For example, when the mode determination unit 401 determines (503) to perform the charging mode, as shown in FIG. 7, the mode determination unit 401 may determine (701) whether the combined charging plug is a plug for fast charging.

In describing the above-described embodiments, it has been described that the modes for processing the charging or discharging of the high-power battery 130 (B1) and the high-capacity battery 140 (B2) are divided into two modes, that is, the fast charging mode and the slow charging mode. However, it is not limited thereto, and the modes for processing the charging or discharging of the high-power battery 130 (B1) and the high-capacity battery 140 (B2) may be divided into three or more modes.

For example, it may further include a general processing mode in which a power distribution ratio of the high-power battery 130 (B1) and the high-capacity battery 140 (B2) to be supplied the power when charging, or a power distribution ratio of the high-power battery 130 (B1) and the high-capacity battery 140 (B2) to be discharged the power when discharging is controlled to be 5:5, and a processing unit (e.g., a general processing unit) for this purpose.

At this time, in determining an operation of the general processing mode through the mode determination unit 401, and in controlling the operations of the high-power battery 130 (B1) and the high-capacity battery 140 (B2) through the general processing unit, it may be configured to perform in a way that it is the same as or similar to the operation of the fast processing unit 403 or the slow processing unit 405.

To describe in more detail, when the mode determination unit 401 determines to perform the charging of battery in the general processing mode based on the received message or the user input, the general processing unit may process to charge so that the charge amount of the high-power battery 130 (B1) and the charge amount of the high-capacity battery 140 (B2) are the same as each other (e.g., 5:5).

At this time, the general processing unit may process to charge a battery having a higher or lower remaining capacity (SoC) among the high-power battery 130 (B1) and the high-capacity battery 140 (B2), and then charge the remaining battery.

In addition, it is not limited thereto, and in charging of the high-power battery 130 (B1) and the high-capacity battery 140 (B2), the general processing unit may process to charge the batteries alternately (or sequentially) in a preset power amount.

According to various embodiments, it may be assumed that the device 100 is connected to at least one battery unit as described above, and the at least one battery unit includes the plurality of high-power batteries 130 (B1) and the plurality of high-capacity batteries 140 (B2).

At this time, the general processing unit may process to evenly distribute and supply 50% of the power provided through the charging plug to the plurality of high-power batteries 130 (B1), then evenly distribute and supply 50% of the power provided through the charging plug to the plurality of high-capacity batteries 140 (B2).

In another embodiment, when the mode determination unit 401 determines to discharge the battery in the general processing mode based on the acceleration information or the user input, the general processing unit may process to discharge so that the discharge amount of the high-power battery 130 (B1) and the discharge amount of the high-capacity battery 140 (B2) are the same as each other (e.g., 5:5).

At this time, the general processing unit may process to discharge a battery having a higher or lower remaining capacity (SoC) among the high-power battery 130 (B1) and the high-capacity battery 140 (B2), and then discharge the remaining battery.

In addition, it is not limited thereto, and in discharging of the high-power battery 130 (B1) and the high-capacity battery 140 (B2), the general processing unit may process to discharge the batteries alternately (or sequentially) in a preset power amount.

According to various embodiments, it may be assumed that the device 100 is connected to at least one battery unit as described above, and the at least one battery unit includes the plurality of high-power batteries 130 (B1) and the plurality of high-capacity batteries 140 (B2).

At this time, the general processing unit may process to evenly distribute 50% of the power provided through the charging plug to the plurality of high-power batteries 130 (B1) and output, then evenly distribute 50% of the power provided through the charging plug to the high-capacity batteries 140 (B2) and output.

Returning to FIGS. 2 and 3 again, it has been described that the device 100 includes one processing unit 110, but it is not limited thereto, and the device 100 may include a plurality of processing units.

Referring to FIGS. 2 and 3, the processing unit 110 may include at least one master processing unit 210 and a plurality of slave processing units 221 and 223.

At this time, each of the plurality of slave processing units 221 and 223 may be configured to be connected to each of the plurality of battery units 230 and 240 as shown in FIG. 2. In addition, the master processing unit 210 may be configured to be connected with the plurality of slave processing units 221 and 223.

However, it is not limited thereto, and as shown in FIG. 3, two or more battery units 320 and 330 may also be configured to be connected to one slave processing unit 223.

Here, the master processing unit 210 may include the mode determination unit 401. In addition, each of the slave processing units 221 and 223 may include the fast processing unit 403 or the slow processing unit 405.

However, it is not limited thereto, and the master processing unit 210 may further include the fast processing unit 403 or the slow processing unit 405.

Each of the slave processing units 221 and 223 may identify the high-power batteries 130 (B1) and the high-capacity batteries 140 (B2) which form the connected battery units, and control the charging or discharging operation of each of the high-power batteries 130 (B1) and the high-capacity batteries 140 (B2) according to the fast processing mode or the slow processing mode.

To describe in more detail, the fast processing unit 403 or the slow processing unit 405 included in each of the slave processing units 221 and 223 may identify the high-power batteries 130 (B1) and the high-capacity batteries 140 (B2) included in each of at least one battery unit according to a control command received from the mode determination unit, and control the charging or discharging operation of each of the high-power batteries 130 (B1) and the high-capacity batteries 140 (B2) according to the fast processing mode or the slow processing mode.

In various embodiments, at least some of the master processing unit 210 and the slave processing units 221 and 223 which form the device 100 may be configured as a battery management unit (BMU) of the battery management system (BMS), or each of the master processing unit 210 and the slave processing units 221 and 223 may be configured as the battery management unit (BMU) of the battery management system (BMS).

In describing various embodiments, the battery discharge may mean load discharge based on the operation of the driving unit, etc. According to an embodiment, the driving unit connected to the battery may include a motor, an engine, or a peripheral device thereof which transmits the power to wheels of the vehicle. In addition, the driving unit may include at least some of various devices capable of controlling output, such as an air conditioning device and a lighting device which are connected to the battery in the vehicle.

According to various embodiments, the vehicle according to various embodiments of the present invention may include not only an automobile including the battery, but also various means of transportation including the battery, such as a motorcycle, a bicycle, a ship, and an airplane, etc.

As described above, according to various embodiments, by forming batteries including cells with different properties and providing a battery management device capable of appropriately controlling them according to the cell properties, it is possible to achieve both the challenges for high output and high capacity of the battery.

According to various embodiments, a battery management device including a plurality of processing units by dividing, which are capable of appropriately control the cells with different properties according to the cell properties may be provided, thereby suppressing an occurrence of problems due to heat propagation that occurs during an operation of the cells.

According to various embodiments, a battery management device which is divided to control cells included in a battery system differently according to their properties may be provided, thereby allowing the cells to perform appropriate operations and functions according to their purpose, thus to maximize efficiency of the battery.

According to the detailed description above, the functions of various embodiments described as being performed by the device 100 are operations processed through the processing unit 110 of the device 100, and may be performed by organically being connected to the device 100 and/or components of the device connected to the device 100.

As described above, although the embodiments have been described with reference to the limited drawings, it will be apparent to those skilled in the art that various modifications and alternations may be applied thereto based on the various embodiments.

For example, adequate effects or results may be achieved even if the foregoing processes and methods are carried out in different order than those described above, and/or the above-described elements, such as systems, structures, devices, or circuits, are combined or coupled in different forms and modes than those described above, or substituted or switched with other components or equivalents.

In particular, when describing with reference to the flowchart, it is described that a plurality of steps are configured and the steps are sequentially executed in a designated order, but it is not necessarily limited to the designated order.

In other words, executing by changing or deleting at least some of the steps described in the flowchart or adding at least one step is applicable as an embodiment, and executing one or more steps in parallel may also be applicable as an embodiment. That is, it is not limited to that the steps are necessarily operated in a time-series order, and should be included in various embodiments of the present invention.

Therefore, other implements, other embodiments, and equivalents to claims are within the scope of claims to be described below.

What is claimed is:

1. A battery management device comprising:
a fast processing unit configured to process a first charge amount or a first discharge amount of a high-power battery in a fast processing mode to be higher than a second charge amount or a second discharge amount of a high-capacity battery;
a slow processing unit configured to process the first charge amount or the first discharge amount of the high-power battery in a slow processing mode to be lower than the second charge amount or the second discharge amount of the high-capacity battery; and
a mode determination unit configured to determine the fast processing mode or the slow processing mode according to a mode selection, and determine an operation of the fast processing unit or the slow processing unit according to the determined mode.

2. The battery management device according to claim 1, wherein in the fast processing mode, the fast processing unit processes to perform charging or discharging of the high-power battery and then charging or discharging of the high-capacity battery, and
in the slow processing mode, the slow processing unit processes to perform charging or discharging of the high-capacity battery and then charging or discharging of the high-power battery.

3. The battery management device according to claim 1, wherein in the fast processing mode, the fast processing unit processes to simultaneously perform charging or discharging of the high-power battery and the high-capacity battery at a preset ratio of the first charge amount and the second charge amount or a preset ratio of the first discharge amount and the second discharge amount, and
in the slow processing mode, the slow processing unit processes to simultaneously perform charging or discharging of the high-power battery and the high-capacity battery at a preset ratio of the first charge amount and the second charge amount or a preset ratio of the first discharge amount and the second discharge amount.

4. The battery management device according to claim 1, wherein when a charging plug is combined to a charging port connected to the high-power battery and the high-capacity battery,
the mode determination unit processes to charge the high-power battery and the high-capacity battery through the fast processing unit based on the power supplied through the charging plug, or charge the high-power battery and the high-capacity battery through the slow processing unit.

5. The battery management device according to claim 1, wherein the mode determination unit processes to discharge the high-power battery and the high-capacity battery through the fast processing unit, or discharge the high-power battery and the high-capacity battery through the slow processing unit, based on a speed change of acceleration according to a user input.

6. The battery management device according to claim 1, wherein the high-power battery is a battery having a first maximum output and a first capacity, and the high-capacity battery is a battery having a second maximum output lower than the first maximum output and a second capacity greater than the first capacity.

7. The battery management device according to claim 1, wherein the high-power battery or the high-capacity battery is configured as cells, modules, or a pack.

8. A battery management method, comprising:
according to a mode selection, by a mode determination unit, determining a fast processing mode of a battery configured to operate a fast processing unit or a slow processing mode of the battery configured to operate a slow processing unit; and
in the fast processing mode, by the fast processing unit, processing a first charge amount or a first discharge amount of a high-power battery to be higher than a second charge amount or a second discharge amount of a high-capacity battery, or, in the slow processing mode, by the slow processing unit, processing the first charge amount or the first discharge amount of the high-power battery to be lower than the second charge amount or the second discharge amount of the high-capacity battery.

9. The battery management method according to claim 8, wherein in the fast processing mode, processing to perform charging or discharging of the high-power battery and then charging or discharging of the high-capacity battery, and
in the slow processing mode, processing to perform charging or discharging of the high-capacity battery and then charging or discharging of the high-power battery.

10. The battery management method according to claim 8, wherein in the fast processing mode, processing to simultaneously perform charging or discharging of the high-power battery and the high-capacity battery at a preset ratio of the first charge amount and the second charge amount or a preset ratio of the first discharge amount and the second discharge amount, and
in the slow processing mode, processing to simultaneously perform charging or discharging of the high-power battery and the high-capacity battery at a preset ratio of the first charge amount and the second charge amount or a preset ratio of the first discharge amount and the second discharge amount.

11. The battery management method according to claim 8, wherein when a charging plug is combined to a charging port connected to the high-power battery and the high-capacity battery,
processing to charge the high-power battery and the high-capacity battery through the fast processing mode based on the power supplied through the charging plug, or charge the high-power battery and the high-capacity battery through the slow processing mode.

12. The battery management method according to claim 8, processing to discharge the high-power battery and the high-capacity battery through the fast processing mode, or discharge the high-power battery and the high-capacity battery through the slow processing mode, based on a speed change of acceleration according to a user input.

13. The battery management method according to claim 8, wherein the high-power battery is a battery having a first maximum output and a first capacity, and the high-capacity battery is a battery having a second maximum output lower than the first maximum output and a second capacity greater than the first capacity.

14. The battery management method according to claim 8, wherein the high-power battery or the high-capacity battery is configured as cells, modules, or a pack.

15. A battery system comprising:
the battery management device including
a fast processing unit configured to process a first charge amount or a first discharge amount of a high-power battery in a fast processing mode to be higher than a second charge amount or a second discharge amount of a high-capacity battery;
a slow processing unit configured to process the first charge amount or the first discharge amount of the high-power battery in a slow processing mode to be lower than the second charge amount or the second discharge amount of the high-capacity battery; and
a mode determination unit configured to determine the fast processing mode or the slow processing mode according to a mode selection, and determine an operation of the fast processing unit or the slow processing unit according to the determined mode; and
two or more battery units;
wherein each of the two or more battery units comprises at least one of the high-power batteries or at least one of the high-capacity batteries.

16. The battery system according to claim 15, wherein the battery management device comprises:
slave processing units connected to each of the two or more battery units; and
a master processing unit connected to a plurality of the slave processing units.

17. The battery system according to claim 16, wherein the master processing unit comprises the mode determination unit, and
each of the plurality of slave processing units comprises the fast processing unit or the slow processing unit.
